(19) United States
(12) Patent Application Publication
(10) Pub. No.: US 2001/0040898 A1
(43) Pub. Date: Nov. 15, 2001

(54) Method, means and arrangements for transmission purposes

(76) Inventors: Allan Hansson, Stockholm (SE); Ingmar Tonnby, Stockholm (SE); Herbert Sander, Saltsjobaden (SE)

Correspondence Address: BURNS DOANE SWECKER & MATHIS L L P, POST OFFICE BOX 1404, ALEXANDRIA, VA, 22313-1404, US

(21) Appl. No.: 09/749,919

(22) Filed: Dec. 29, 2000

(30) Foreign Application Priority Data
Dec. 30, 1999 (SE) 9904857-1

(51) Int. Cl. H04J 3/24; H04J 3/12; H04J 3/04

(52) U.S. Cl. 370/473; 370/474; 370/524; 370/535

(57) ABSTRACT

The present invention relates to a method of transferring a number of carried data streams (a, b, c, d) via a common carrying data stream (1), from a first table operated device (A) to a second table operated device (B). A so-called carried data stream is a sequence of mutually associated stream elements. The carrying data stream is organised into frames and each frame includes stream elements belonging to one or more different carried data streams. Frame multiplexing is used to combine stream elements belonging to one or more different data streams into a common frame, wherein used frame structures include a frame descriptive index which is included by a reference to a position in a frame descriptive table (FDTA, FDTB). A control stream (a, a′) is established between a control device (23, 23′), the first table operated device (A) and the second table operated device (B). Control information required to establish a new frame structure, to change an existing frame structure, or to remove an existing frame structure, is transferred between the control device (23, 23′), the first table operated device (A), and the second table operated device (B), via the control stream (a, a′).

### FIELD OF INVENTION

The present invention relates to a method, various devices and various arrangements for transmitting a number of carried data streams from a first table operated device to a second table operated device, via a common carrying data stream.

A carried data stream is a sequence of associated stream elements, and the carrying data stream is organised into frames where each frame may include stream elements belonging to one or more different carried data streams.

### DESCRIPTION OF THE BACKGROUND ART

It has long been known that multiplexed transmission of digital information can be effected in accordance with different principles.

The two general principles most used for the transmission of information according to the above are Time Division Multiplexing (TDM) and data packet handling or packet technology, where STM (Synchronous Transfer Mode) is an example of TDM.

STM is characterised by a limited broadband flexibility, but has high service quality. STM enables isochronous transmission and a constant low delay to be obtained. However, it is not possible to change those streams to be sent synchronously in the stream time. This is effected more or less rapidly, by check or control signalling. Thus, there is no direct support in STM for effective transmission of finite streams. By finite streams is meant streams that have a definite beginning and a definite end. ISDN, SDH and DTM are examples of the various transmission principles used within STM.

ISDN enables bandwidths to be allocated in steps of 64 kbit/s from 64 kbit/s to 2 Mbit/s, and is used in practice solely for pipes of constant bandwidth.

SDH provides a transmission technique where dynamic switching is inappropriate, since it is not generally possible to change channel allocation without causing interference on other established channels. SDH forms a hierarchical structure.

DTM (Dynamic Transfer Mode) is a fast circuit switching technique that is broadband optimised. DTM includes a predetermined bandwidth granularity in steps of 512 kbit/s. The known technology provides no support for narrow pipes. DTM supports a change of allocated bandwidth in such steps by signalling.

Packet technology is characterised by significant bandwidth flexibility through the medium of static multiplexing. Packet technology does not support isochronous streams directly. However, this can be achieved with certain applications in which the packet can be forwarded so that isochronous transmission can be readily recreated under certain conditions. Certain difficulties exist in guaranteeing high service quality at high loads. Asynchronous transfer modes (ATM) and Internet Protocols (IP) are examples of the various transmission principles that can be used within packet technology.

ATM uses a fixed cell size that limits the possibility of short delays combined with the use of high broadbands for narrowband streams. ATM includes no support for the transmission of finite streams. In general, ATM provides good service quality, although this presumes good control of the load situation.

The problem of ensuring service quality is also found with IP, particularly in respect of loaded networks and when it is necessary to guarantee the quality of a large part of the traffic. IP provides support for the transmission of finite streams, as a result of variable packet lengths. IP also provides the possibility of transmitting isochronous streams in real time even though such transmission is relatively complicated, particularly when high service quality and short delays are required.

### SUMMARY OF THE INVENTION

Technical Problems

When considering the earlier standpoint of techniques as described above and when taking a starting point from a method and an arrangement for transmitting a number of carried data streams from a first table operated device to a second table operated device via a common carrying data stream, where the carried data stream is a sequence of mutually related stream elements, where the carrying data stream is organised in frames, and where each frame can include stream elements that belong to one or more different carried data streams, it will be seen that a technical problem resides in enabling available frame structures to be changed dynamically in accordance with prevailing or current transmission requirements.

With respect to time division multiplexing in synchronous transmission modes, a technical problem resides in varying the allocation of available bandwidths to carried data streams synchronously with the need to change the transmission of carried data streams.

With respect to time division multiplexing in synchronous transmission modes, a technical problem resides in enabling available bandwidths to be distributed selectively in accordance with variation in the bandwidth requirement of the carried streams and to effect said distribution while retaining the stream integrity of all carried streams, in other words without losing or distorting information during transmission.

Another technical problem is one of providing with one and the same technique isochronous transmission, good bandwidth flexibility with selective granularity and within a wide area, good support for varying bandwidths, guaranteed service quality, inclusive of a short delay, rapid and dynamic switching, and transmission of finite streams, where said technique can also be applied recursively.

Solution

A definition of the term frame multiplexing will be given in conjunction with a description of the solution. By frame multiplexing is meant multiplexing of carried data streams within a common carrying data stream, the principle of frame multiplexing is the basis of the present invention and is described in detail in Swedish Patent Application SE-99 03808-5, which can be considered to form part of the present Application. This principle will not therefore be described in detail in this document.

With the intention of solving one or more of the aforesaid problems, the present invention takes as its starting point a method and an arrangement for transferring a number of carried data streams from a first table operated device to a second table operated device via a common carrying data stream, where a carried data stream is a sequence of mutually associated stream elements and the carrying data stream is organised into frames, and where each frame can include stream elements that belong to one or more different carried data streams.

The term table operated device will be understood as meaning a device that includes a frame descriptive table which discloses how different frame structures are compiled. A table operated device can transform between carried data streams and a carrying data stream in accordance with a frame descriptive table used to this end. This table can be changed or updated in accordance with instructions from a control means.

Table operated devices operate in groups of two or more, where a common table is used within the group so as to thereby use a common definition of used frame structures.

From this starting point, and with the intention of enabling available frame structures to be changed dynamically in accordance with prevailing, i.e. current, transmission requirements, it is proposed in accordance with the present invention that frame multiplexing is used to combine stream elements that belong to one or more different data streams into a common frame.

The frame structures used include a frame descriptive index which, in turn, includes a reference to a position in a frame descriptive table. This table is stored as a local description of frame structures used in the table operated device that uses common frame structures, i.e. in both the first table operated device and the second table operated device.

According to the present invention, so-called check or control streams are established between a so-called control unit and the first table operated device and the second table operated device, wherein requisite control information for establishing a new frame structure, changing a present frame structure or deleting an existing frame structure, is transmitted between the control unit and the first table operated device and the second table operated device via said control streams.

It is proposed in accordance with the present invention that the control information used will include at least the information required to ambiguously determine the size and position of respective stream elements in a changed frame structure, and also sufficient information to ensure that an effected change will include a guaranteed consistency between the control unit and the first and second table operated devices respectively with regard to the frame descriptive tables used.

Examples of such exchanges of control information in conjunction with different changes in the frame structures used will be given in the following detailed description of proposed embodiments. It will be understood, however, that described changes constitute fundamental changes, and that other more complex changes can be made within the scope of the inventive concept.

According to the present invention, the control unit may be adapted to form internally the frame descriptive table in accordance with requisite changes. In the case of this application, the control information transferred includes a thus formed table.

According to this embodiment, the frame descriptive table is transferred to the first and the second table operated devices and said first and second table operated devices carry out the requisite control in co-action with the control unit, for guaranteeing the consistency of the frame descriptive tables used by the first and the second table operated devices respectively.

Requisite control streams can be carried either partially or completely by the carrying stream, or can be sent separately from the carrying stream.

According to one inventive method, the first table operated device may be adapted to multiplex incoming data streams by selecting a frame structure dynamically in accordance with current transmission requirements, when building a carrying data stream.

The first table operated device includes a so-called presence vector which represents the current transmission requirement of the first table operated device.

A frame selecting unit includes a number of frame element vectors and each position in the frame descriptive table is represented by a frame element vector.

Respective frame element vectors include a position for each position in the presence vector, where each position shows whether or not a stream element that is marked in the presence vector can be transmitted by means of the frame structure represented by the table position in the frame descriptive table that belongs to the frame element vector concerned.

The frame selecting unit is able to find a frame structure that suits the presence vector concerned, by matching between a presence vector and the frame element vectors. This enables the first table operated device to choose dynamically a frame structure according to current, i.e. prevailing, transmission requirements when compiling a carrying data stream.

According to one preferred embodiment, the frame element vectors are updated in conjunction with updating the frame descriptive table, through the medium of instructions received from the control unit.

According to the inventive method, the second table operated device can be adapted to demultiplex an incoming carrying data stream, by virtue of the second table operated device being adapted to extract carried data streams from the incoming carrying data stream.

The present invention also relates to a first table operated device that is adapted to multiplex incoming streams, and a second table operated device that is adapted to demultiplex an incoming carrying data stream. These table operated devices are able to co-act through a control unit and may be adapted to operate in accordance with the inventive method.

According to the invention, the first table operated device is adapted to select dynamically a frame structure that corresponds to a current transmission requirement with respect to compiling the carrying data stream.

This is possible by virtue of the first table operated device being related to a number of contact points for incoming streams, a reception buffer in conjunction with respective contact points and adapted to store incoming stream elements, and a transmission buffer adapted to store outgoing stream elements.

With the intention of enabling the selection of a frame structure that corresponds to the transmission requirement of a first table operated device at that moment in time, it is proposed in accordance with a preferred embodiment of the invention that a so-called presence vector having a position for each reception buffer is adapted to show in each position whether or not a stream element is stored in an associated reception buffer. The embodiment also enables information in respective positions in the presence vector to disclose properties of stored stream elements, such as size, when stream elements of different sizes are received in one and the same reception buffer.

A frame selecting unit is adapted to translate this presence vector to a table position in the frame descriptive table belonging to the first table operated device, said position disclosing a frame structure that corresponds to a transmission requirement in accordance with the presence vector concerned.

A frame compiling unit is adapted to compile a frame in accordance with a given frame structure, by storing in the transmitter buffer an index that corresponds to a concerned table position, and by transferring stream elements from respective reception buffer to the transmission buffer in accordance with the given frame structure.

A transmitter unit is adapted to send the compiled frame from the transmitter buffer to some other table operated device, either directly or indirectly, such as to the second table operated device, via the carrying data stream.

With the intention of being able to handle stream elements of different types from one and the same data stream, it is proposed in accordance with the present invention that stream elements from one and the same incoming stream comprised of different types of stream elements can be allocated different positions in the presence vector or may be represented by different numbers in the same position in the presence vector.

The frame selecting unit includes a number of frame element vectors and each position in the frame descriptive table, in other words each available frame structure, is represented by a frame element vector.

Respective frame element vectors included a position for each position in the presence vector, and each position is adapted to show whether or not a stream element that is stored in a reception buffer, and therewith also marked in the presence vector, can be transmitted by means of the frame structure represented by the table position that belongs to the frame element vector concerned.

The frame selecting unit is able to find a frame structure that suits the presence vector concerned and thus find a frame structure that corresponds to the current transmission requirement, by matching between a presence vector and the frame element vectors.

According to the present invention, the second table operated device is adapted to extract carried data streams from the incoming carrying data stream.

The second table operated device is related to an input buffer which is adapted to receive frames belonging to the incoming carrying data stream, a number of contact points for outgoing streams, and at least one output buffer in connection with respective contact points.

With the intention of enabling stream elements to be readily extracted from received frames, it is proposed in accordance with the present invention that an extraction unit is adapted to extract stream elements from received frames on the basis of the index in received frames and the local frame descriptive table, and send respective elements to the intended output buffer.

It is also proposed in accordance with the invention that the stream element information present in the frame descriptive table will include information as to the output buffer in which the stream elements concerned shall be stored.

The present invention enables the frame multiplexing principle to be used recursively. With the intention of showing this, the present invention proposes a first arrangement that includes a first table operated device in accordance with the above description, and a third table operated device.

A first stream of the streams arriving at the first table operated device constitutes a carrying stream from the third table operated device, and said first table operated device is adapted to transmit a carrying data stream in accordance with the frame multiplexing principle.

According to one preferred embodiment of the invention, the first table operated device is adapted to receive from the third table operated device frame structures of mutually different sizes and mutually different types of stream elements.

The first table operated device and the third table operated device may be two table operated devices that belong to mutually different units.

It is also possible for the first table operated device and the third table operated device to be two operated devices that belong to a common multiplexing unit.

The present invention also relates to a second arrangement that includes a second table operated device according to the above description, and a fourth table operated device, where a carrying data stream incoming to the second table operated device includes a first carried data stream which per se forms a carrying data stream.

The fourth table operated device is adapted to receive a carrying data stream and also to receive the first carried data stream from the second carried operated device.

According to one proposed embodiment of the invention, the second table operated device and the fourth table operated device are two table operated devices that belong to a common demultiplexing unit.

The second table operated device and the fourth operated device may, alternatively, be two table operated devices that belong to mutually different units.

The present invention also relates to a third arrangement that includes both a first and a second arrangement according to the above description, where the first and the second table operated devices co-act through the medium of a first frame descriptive table, and the third and fourth table operated devices co-act through the medium of a second frame descriptive table.

The first and the second frame descriptive tables may be managed by a common control unit.

Alternatively, the first frame descriptive table may be managed by a first control unit and the second frame descriptive table managed by a second control unit.

Advantages

The advantages primarily characteristic of a method, different devices and different arrangements according to the invention reside in the possibility of carrying any type of data stream whatsoever via a common carrying data stream in a flexible and effective manner.

The main control information is transmitted in response to a change in one or more frame structures, such as in response to the introduction or deletion of a carried data stream, as distinct from data packet handling where each packet carries with it a given amount of control or address information, and the control information handled in accordance with the present invention provides a more dynamic and flexible transmission method than can be obtained by time division multiplexing, while guaranteeing stream integrity and short delay times at the same high level as that obtained with time division multiplexing.

### BRIEF DESCRIPTION OF THE DRAWINGS

A method comprising features associated with the present invention will now be described in more detail by way of example and with reference to the accompanying drawings, in which

FIG. 1 is a schematic and highly simplified illustration of the transmission of a number of data streams from a first table operated device to a second table operated device;

FIG. 2 illustrates schematically the division of an index used as a reference to a frame descriptive table;

FIG. 3 is a schematic illustration of a number of mutually sequential frames;

FIG. 4 is a schematic illustration of a first and a second table operated device belonging to mutually different networks;

FIG. 5 is a schematic illustration of a first frame structure adapted to carry a control stream;

FIG. 6 illustrates schematically the compilation of a newly formed frame structure adapted to carry a new data stream;

FIG. 7 illustrates schematically an addition of a new carried data stream to an existing frame structure;

FIG. 8 illustrates schematically the deletion of an existing carried data stream from an existing frame structure;

FIG. 9 illustrates schematically a change of available space for an existing carried data stream in an existing frame structure;

FIG. 10 illustrates schematically the deletion of an existing frame structure;

FIG. 11 is a schematic and highly simplified illustration of an arrangement according to the present invention;

FIG. 12 is a schematic illustration of an arrangement that includes four mutually co-acting table operated devices in a recursive application of frame multiplexing; and

FIG. 13 illustrates schematically a further embodiment of an arrangement that includes four co-acting table operated devices in a recursive application of frame multiplexing.

### DESCRIPTION OF EMBODIMENTS AT PRESENT PREFERRED

FIG. 1 thus shows a method of transferring data information from a first table operated device A to a second table operated device B. The illustrated information is comprised of a number of so-called carried data streams, of which some a, b, c, d have been shown in the Figure and which are transferred by means of a common carrying data stream 1 and then recreated on the receiving side, in the illustrated case the second table operated device B.

A carried data stream is comprised of a sequence of associated stream elements.

According to the present invention, the carrying data stream 1 shall be organised into frames, these frames being shown schematically in FIG. 3 as frames having the mutually different frame structures 11, 12, 11, 15, . . . , 1n. The reference on a frame denotes the structure possessed by the frame. Thus, mutually sequential frames may be allocated different structures, while different frames may have the same structure.

This representation of stream elements belonging to one or more different data streams in a common frame is designated frame multiplexing. Frame multiplexing is described more specifically in Patent Application SE 99 03808-5 and will not be described in further detail in this document.

Each frame includes a frame descriptive index that includes a reference to a position in a frame descriptive table FDTA, FDTB stored in a memory Am, Bm belonging to the first and the second table operated devices A, B, respectively.

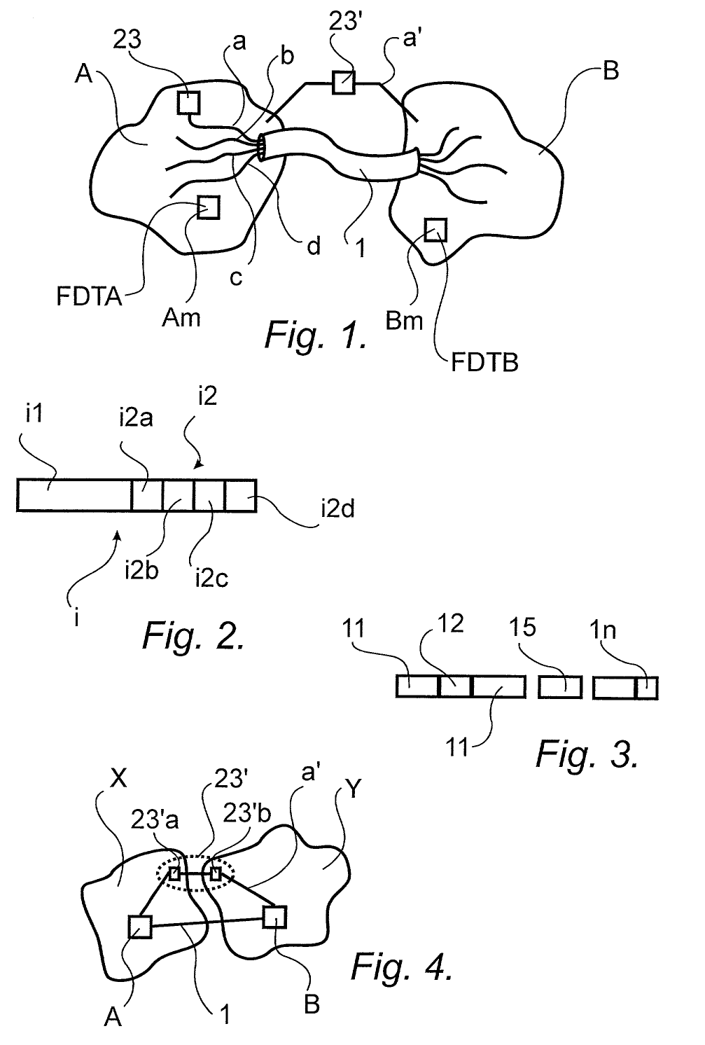

This reference may include a pointer to a position in the frame descriptive table. FIG. 2 illustrates the possibility of dividing the index “i” into two parts i1, i2 for instance, where a first part i1 includes a pointer to a position in a frame descriptive table, said position defining a number of data streams that can be transferred with a given frame structure. A second part i2 of the index can include a mask which can define a number of data streams as being transferable with a current frame structure.

For instance, if the mask includes four data bits i2a, i2b, i2c, i2d, the mask can, per se, indicate whether or not stream elements from four different data streams are present in a current frame structure. For instance, a “zero” can indicate in one of the four positions that a stream element represented by this position is not found in the frame structure, whereas a “one” indicates that a stream element from this data stream is included.

This enables streams that are continuous over longer time intervals to be represented in different positions in the frame descriptive table, whereas streams that occur in bursts can be represented by a position in the mask, where said mask can be readily adapted from frame to frame.

Requisite control information for establishing a new frame structure, changing an existing frame structure, or removing an existing frame structure, is sent from a control unit 23 to the first table operated device A and the second table operator device B via so-called control streams. These control streams will be shown hereinafter as a somewhat simplified control stream, which has been given the index a or a′ in different embodiments.

The control information includes a determination of the type of change to which the information refers and in which phase of the change the control information in question shall be used.

According to one proposed embodiment of the invention, the control stream a′ can be transmitted between a control unit 23′ and the first and the second table operated device A, B separate from the carrying data stream 1. As will be seen from the Figure, the control unit 23′ may be a unit that is separate from the first and the second table operated devices A, B.

Alternatively, the control unit 23 may be a part of or related to the first or the second table operated device. In the Figures, the control unit 23 forms a part of the first table operated device A.

Regardless of whether a control unit is related to the first table operated device (control unit 23′) or forms a separate unit (control unit 23′), the control stream can be transmitted, either completely or partially, as a carried data stream a or as a separate data stream a′.

By completely or partially is meant that when the control streams shall be sent between the control unit and different concerned table operated devices, as is the case in practice, said control streams can in some cases, or between certain nodes in a network, be transmitted as a carried data stream, and in other cases as a data stream that is separate from a carrying stream. A control stream that is sent as a carried data stream is handled in precisely the same manner as other carried data streams.

It will also be understood that in a practical application, a control unit 23′ may comprise two mutually separated control units 23′a, 23′b as shown in FIG. 4. In this case, the first table operated device A functions in a first network X and the second table operated device B functions in a second network Y. The control unit 23′ is represented by a first control unit 23′a in the first network X, and a second control unit 23′b in the second network Y, said two control units co-acting with each other and performing the common function of a control unit 23′. Neither need the control units 23′a, 23′b necessarily be included in the network X and the network Y, respectively.

In the following description, the control stream is at times a data stream a carried by the carrying data stream 1, and at other times a data stream a′ separate from the carrying data stream 1. It will be understood, however, that all subsequent embodiments can be implemented regardless of whether the control stream is transmitted as a stream a carried by the carrying data stream 1 or of whether the control stream is transmitted separate a′ from the carrying data stream 1 between the control unit and the first and second table operated devices A, B.

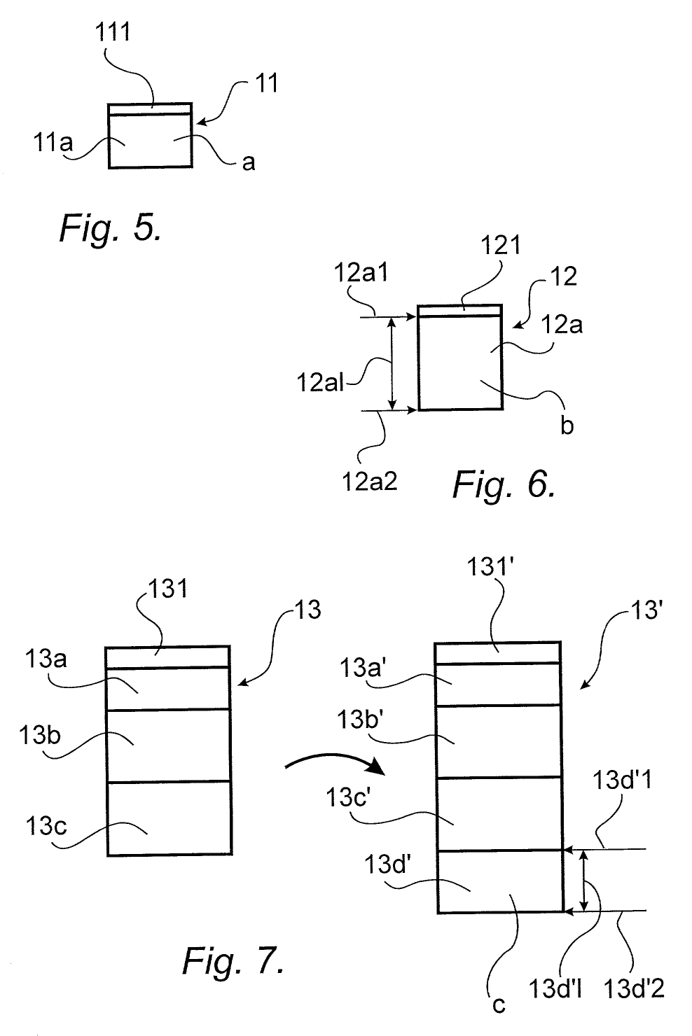

FIG. 5 is intended to show a predefined frame structure 11 that includes a stream element 11a belonging to the control stream a, and a frame descriptive index 111. One such predefined frame structure may be found in an initial stage of a system, so as to enable configuration of different frame structures to be initiated.

A change includes the transmission of a number of messages from the control unit 23 to the first table operated device A and to the second table operated device B via the control current a, and by phase in the change is meant which of these messages shall be sent. It can be said generally that all changes include a number of different phases, which constitute either a call message and/or an answer message. These messages contain control information and different changes can be carried out in different ways.

One method of carrying out different changes will be described in the following, although it will be understood that these changes can be implemented in a practical application with the aid of other messages sent between the control unit and the two table operated devices.

Regardless of the manner in which different changes are implemented, it will be understood that the control information shall be determined unambiguously with respect to size and position of respective stream elements included in a changed frame structure. An effected change shall also include guaranteed consistency between the control unit 23 and respective first and second table operated devices with regard to the frame descriptive tables used.

The control information may also include information in addition to that which is absolutely required or to that given in the following description.

According to this description, information belonging to data streams is transferred from the first table operated device A to the second table operated device B. It will be obvious to the person skilled in this art, however, that in the case of application in which there is a requirement for bidirectional communication, data streams can flow in both directions between two units that include table operated devices, and also how mux/demux pairs shall be arranged in such practical applications.

A number of typical changes to a frame structure will now be described, together with a manner of effecting such changes.

FIG. 6 illustrates one possible change, in which a new data stream b is added when creating a new frame structure 12. This change may constitute a first change when a system is started-up while using the inventive method. The change may also constitute a change where it is desired to create a totally new frame structure among a number of existing frame structures.

A totally new frame structure 12 can thus be created when adding a new data stream b, with the aid of the predefined frame structure 11 with solely one control stream a, or with another frame structure that carries the control stream a.

This is achieved by the control unit 23 sending control information to the first and the second table operated devices A, B via the control stream a, where the control information includes a type-determination of the message, in other words that the message concerns information that is required to create a new frame structure 12 with an incoming data stream b.

The control information includes information necessary to determine unambiguously the position and the size of the stream element in the new frame. This information may, e.g., include a disclosure of a new frame descriptive index 121, a disclosure of the identity of the new data stream b, a disclosure of the start address 12a1 for the new stream element 12a in the new frame structure 12, and a disclosure of the length 12a1 of the new stream element 12a.

The first and the second table operated devices A, B return control information to the control unit 23 via the control stream a, which includes a type-determination of the message, in other words that the message concerns information that constitutes a reply to the first message.

The control information also includes identification of the new frame descriptive index 121, and a terminating address 12a2 for the new stream element 12a in the new frame structure 12.

FIG. 7 shows another change which may concern the introduction of a new data stream c in an existing frame structure 13, shown here with the index 131, and the stream elements 13a, 13b and 13c.

In the case of a change of this nature, it is proposed in accordance with the present invention that a control unit 23 creates a new frame structure 13′ where a new stream element 13d′ belonging to the new data stream c is added after the last stream element 13c′ belonging to a frame according to the old frame structure 13.

This change is effected by the control unit 23 sending control information to the first and the second table operated devices A, B via the control stream a, where the control information includes a type-determination of the message, in other words that the message concerns information required to include a new data stream c in an existing frame structure 13.

The control information also includes an identification of the old frame descriptive index 131, a disclosure of a new frame descriptive index 131′, a disclosure of an identity of the new data stream c, a disclosure of the start address 13d′1 of the new stream element 13d′ in the new frame structure 13′, and a disclosure of the length 13d′1 of the new stream element 13d′.

The first and the second table operated devices A, B return control information to the control unit 23 via the control stream a, which includes a type-determination of the message, in other words that the message concerns information that constitutes a reply to the first message.

This control information also includes an identification of the new frame descriptive index 131′ and a terminating address 13d′2 of the new stream element 13d′ in the new frame structure 13′.

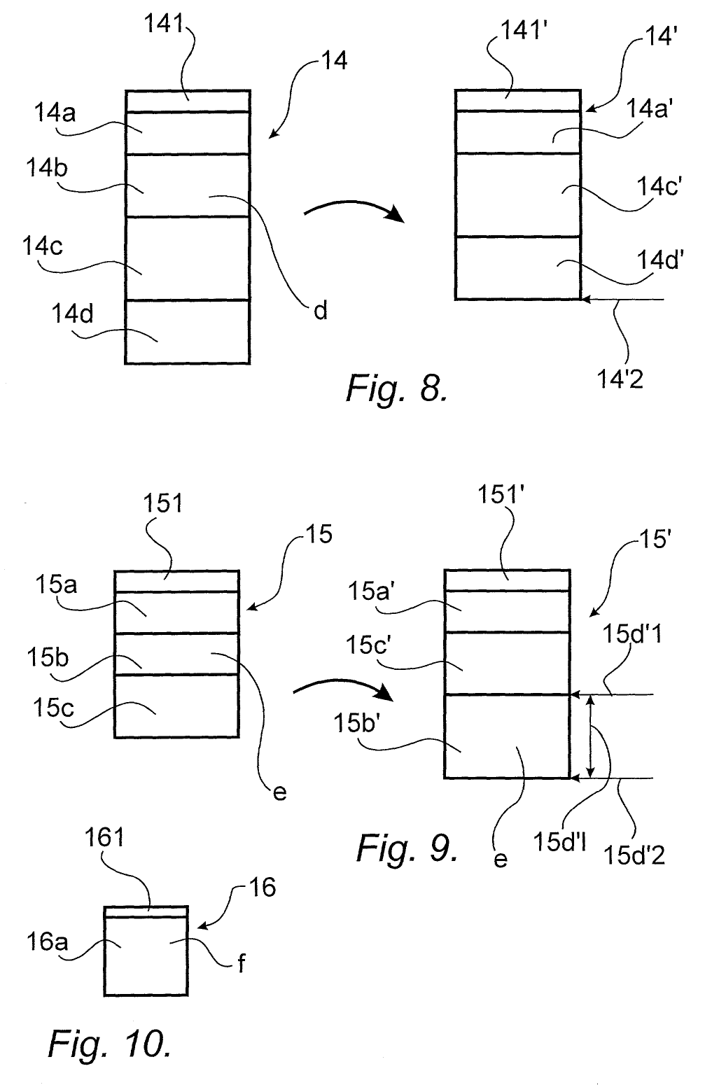

FIG. 8 illustrates another change, which may concern the deletion of an existing data stream d in an existing frame structure 14. In the case of a change of this nature, it is proposed in accordance with the present invention that the control unit 23 creates a new frame structure 14′ that does not include the stream element 14b concerned. //The stream element cannot be removed from a new frame structure//

This change is effected by the control unit 23 sending control information to the first and the second table operated devices A, B via the control stream a, said control information including a type-determination of the message, in other words that the message concerns information required to remove an existing data stream d from an existing frame structure 14.

The control information also includes an identification of the old frame descriptive index 141, a disclosure of a new frame descriptive index 141′, and a disclosure of the identity of the removed data stream d.

The first and the second table operated devices A, B return control information to the control unit 23 via the control stream a, which includes a type-determination of the message, in other words that the message is concerned with information that constitutes a reply to the first message.

This control information also includes an identification of the new frame descriptive index 141′, and a terminating address of the new frame structure 14′2.

FIG. 9 shows another change, which may concern a change of available space for an existing stream element 15b in an existing frame structure 15. In the case of a change of this nature, it is proposed in accordance with the present invention that the control unit 23 creates a new frame structure 15′ where the stream element 15b concerned is removed, where possible subsequent stream elements 15c′ accompany possible preceding stream elements 15a′, and where a new stream element 15b′ with the new space is added to the end of the frame structure 15′ concerned.

This is achieved by the control unit 23 sending control information to the first and the second table operated devices A, B via the control stream a, where the control information includes a type-determination of said message, in other words that the message is concerned with information required to change available space for an existing stream element 15b in an existing frame structure 15.

The control information also includes an identification of the old frame descriptive index 151, the disclosure of a new frame descriptive index 151′, the disclosure of the identity of the data stream e concerned, the disclosure of a start address 15b′1 for a new stream element 15b′ in the new frame structure 15′, and the disclosure of the length 15b′1 of the new stream element 15b′.

The first and second table operated devices A, B return control information to the control unit 23 via the control stream a, which includes a message type-determination, i.e. that the message is concerned with information that constitutes a reply to the first message.

This control information also includes an identification of the new frame descriptive index 151′, together with the terminating address 15b′2 of the new stream element 15b′ in the new frame structure 15′.

All of the described changes to a frame structure described above (shown in FIGS. 4, 5, 6 and 7) are terminated by updating the frame descriptive table FDTA, FDTB in accordance with instructions given by both the first and the second table operated devices A, B, whereafter an acknowledgement message is sent from the first and the second table operated devices A, B to the control unit 23, and from the control unit 23 to the first and the second table operated devices A, B via the control stream a, said control information including a type-determination of the message, in other words that the message is concerned with information required to terminate a change.

This control information also includes an identification of the new frame descriptive index.

The new frame structure can be used subsequent to these terminating acknowledgement messages.

Another change, shown in FIG. 10, may involve the removal of an existing frame structure 16. This removal may be applicable when an existing data stream shall be removed from an existing frame structure where the data stream concerned is the sole data stream that is carried by said frame structure, in other words the frame structure 16 includes only one stream element 16a. In the case of a change of this nature, it is proposed in accordance with the invention that a corresponding position in the frame descriptive table FDTA, FDTB of the first and the second table operated device A, B is removed.

This is effected by the control unit 23 sending control information to the first and the second table operated devices A, B via the control stream a, said control information including a type-determination of the message, in other words that the message is concerned with information that requires the removal of an existing frame structure 16.

The control information also discloses the frame descriptive index 161 for the removal of frame structure 16.

The first and the second operated devices A, B return the control information to the control unit 23 via the control stream a, which includes a type-determination of the message, i.e. that the message is concerned with information that constitutes a reply to the first message.

This control information also discloses the frame descriptive index 161 for removal of the frame structure 16.

The above example in which a frame structure carries only one data stream is a particular case of a situation in which it may be necessary to remove a frame structure. It will be understood that it may be necessary to remove a frame structure in many other instances, and that such removal is effected each time a frame structure becomes redundant, in other words when the frame structure is no longer unique, which may occur when a stream element is removed from a frame structure and the new frame structure forms a duplicate of an existing frame structure where the sole difference between said existing frame structure and the earlier unchanged frame structure resides precisely in the removed stream element.

According to the present invention, it is possible to allow the transmission of control information belonging to two or more changes which concern the same frame structures or different frame structures in a common stream element belonging to the control stream a.

When an embodiment is applied in which the control stream a constitutes a data stream carried by the carrying stream 1, the control stream a can be handled in the same way as any other carried stream whatsoever, with the aid of the changes described above.

For instance, a frame structure that includes a stream element intended to carry the control stream can be selected when there is a need to carry both the control stream and other carried data streams with the carrying stream. This also enables the selection of a frame structure where no stream element is found for the control stream if no control information shall be transmitted, therewith enabling effective use of available transmission capacity.

The present invention also enables all available frame structures to include a stream element belonging to the control stream a. In the case of such an embodiment, the number of different frame structures required is not as large as when the control stream a is included solely in certain frame structures, although the carrying frames will then include unused transmission capacity when no control information is sent.

It is also possible to allow a frame structure, the earlier mentioned predefined frame structure 11, to be the only frame structure that includes a stream element 11a belonging to the control stream a, and for all control information to be transmitted by means of the frame structure 11.

According to the above description, the practical change or updating of the local frame descriptive tables in respective first and second table operated devices A, B is carried out under the supervision of the control unit 23.

However, according to one preferred embodiment of the present invention, the control unit 23 may be adapted to form the frame descriptive table internally in accordance with required changes, in the event of a change. In the case of such an embodiment, it is proposed in accordance with the present invention that the control information sent from the control unit 23 to the first and the second table operated devices A, B includes a thus formed table.

After having sent the frame descriptive table to the first and the second table operated devices, it is also suitable to guarantee the consistency between the control unit 23 and the first and the second table operated devices respectively with regard to the frame descriptive table used.

It will be understood that the above examples of how a change can be effected in a frame structure are given solely by way of example and that there are other ways of indicating unambiguously the position and size of a stream element in a frame structure. Such information may include a start address and size, a terminal address and size, or a start and terminating address of a stream element. When a common size is used for all stream elements, it is sufficient to indicate only the start address or terminating address. By address is meant an internal address in a frame structure.

It is also possible to indicate solely the size of and the mutual order between respective stream elements in a frame structure in order to unambiguously determine the size and position of the stream elements included. It is also possible, for instance, to indicate the mutual order between the stream elements in the frame structure, through the order in which they are given in the frame descriptive table.

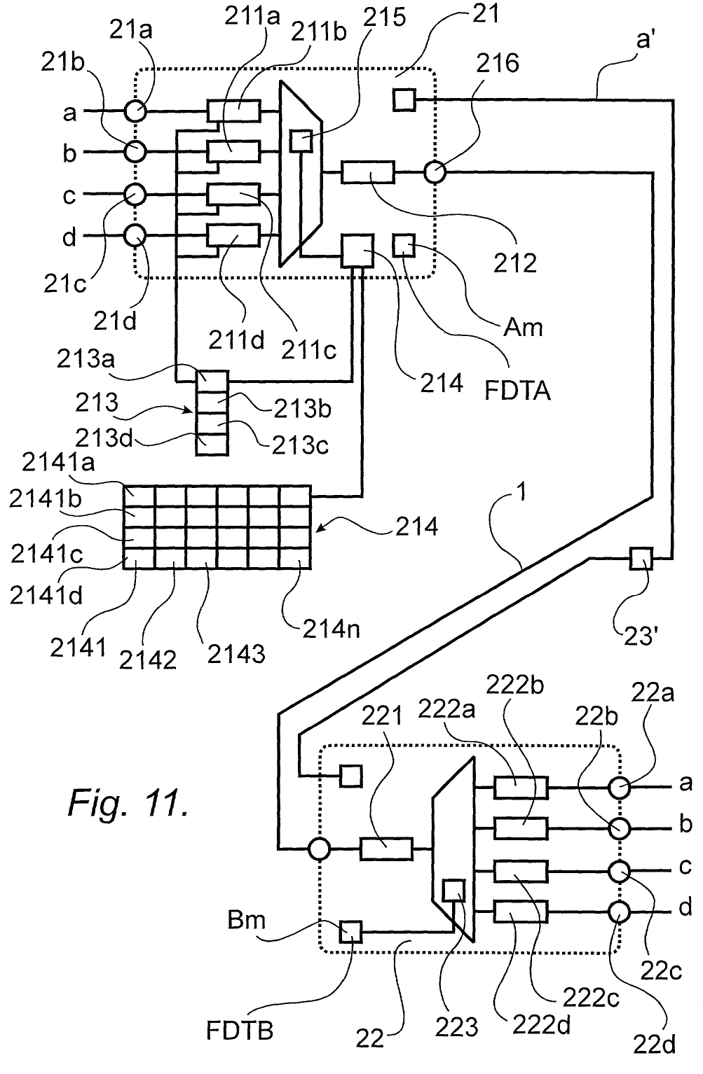

As will be seen from FIG. 11, the first table operated device 21 is adapted to multiplex incoming data streams a, b, c, d in accordance with the inventive method, and that said first table operated device 21 is also adapted to select dynamically a frame structure according to current transmission requirements when compiling a carrying data stream.

The first table operated device 21 includes a so-called presence vector 213 which represents current transmission requirements of the first table operated device 21.

A frame selecting unit 214 includes a number of frame element vectors 2141, 2142, 2143, . . . , 214n, and each position in the frame descriptive table FDTA is represented by a frame element vector.

Respective frame element vectors 2141 include a position 2141a, 2141b, 2141c, 2141d for each position 213a, 213b, 213c, 213d in the presence vector 213, where each position shows whether or not a stream element marked in the presence vector 231 can be transmitted by the frame structure represented by the table position in the frame descriptive table FDTA that belongs to the frame element vector concerned.

A frame structure that suits the presence vector concerned can be found by the frame selecting unit 214, by matching between a presence vector and the frame element vectors. This enables the second table operated device to select dynamically a frame structure according to current transmission requirements when compiling the carrying data stream 1.

According to one preferred embodiment, the frame element vectors shall be updated in conjunction with updating the frame descriptive table, by instructions received from the control unit 23′. A new or changed frame element vector is not taken into use until the change causing the new or changed frame element vector has been terminated and consistency has been guaranteed between concerned table operated devices and the control unit with respect to which frame descriptive table shall be used.

According to the inventive method, the second table operated device 22 may be adapted to demultiplex an incoming carrier data stream 1, by causing said device 22 to extract carried data streams a, b, c, d from the incoming carrying data stream 1.

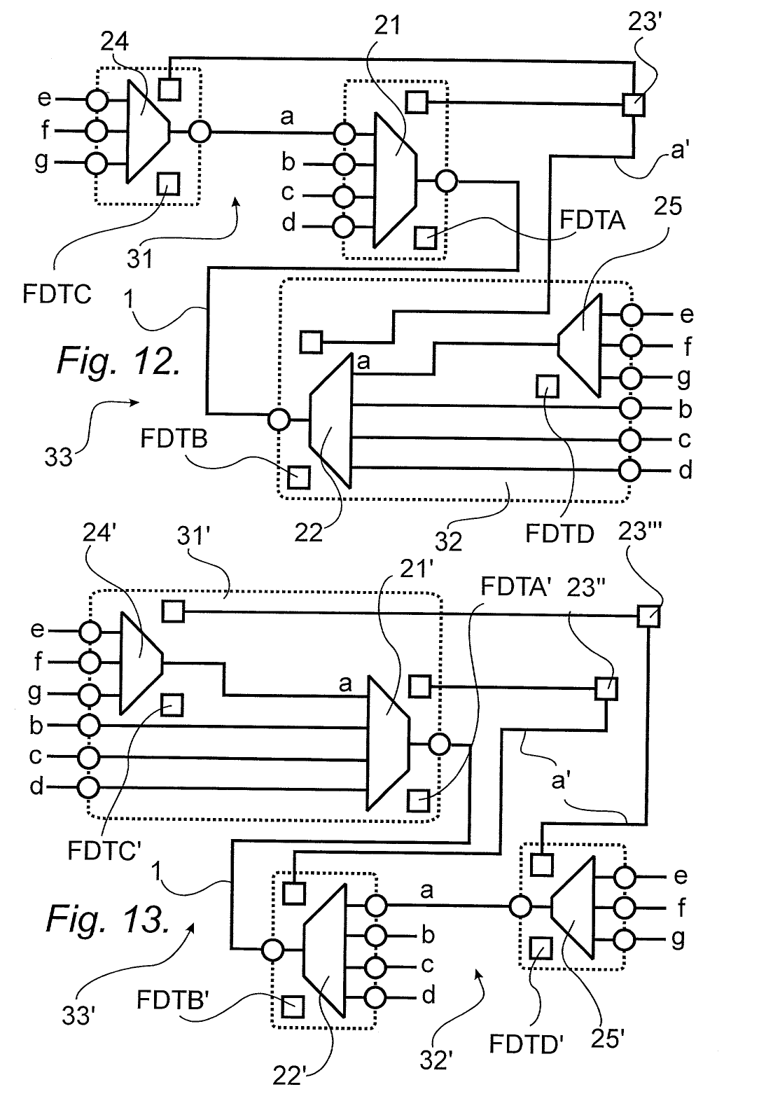

According to one preferred embodiment of the invention, the first table operated device forms a recursively constructed carrying data stream from the incoming data streams, and the second table operated device extracts carried data streams from a recursively constructed carrying data stream. This recursion will be described below in conjunction with an arrangement that includes different table operated devices and combinations of table operated devices described later on with reference to FIGS. 12 and 13.

The present invention also relates to different table operated devices according to FIG. 11, adapted to operate in accordance with the described method.

These table operated devices comprise a first table operated device 21 that is adapted to multiplex incoming streams a, b, c, d, and a second table operated device 22 that is adapted to demultiplex an incoming carrier data stream 1.

A table operated device is defined by including a frame descriptive table that discloses how different frame structures are constructed, and by the fact that said table can be changed or updated in accordance with instructions from a control unit, as described in the inventive method.

Table operated devices work in pairs, where a common table is used for using a common definition on used frame structures.

The first table operated device and the second table operated device described below thus comprise table operated devices that are adapted particularly to perform multiplexing and demultiplexing functions respectively. It will be understood, however, that the described table operated devices may also co-act with other table operated devices not described in this document. Examples of such table operated devices are units adapted to form a so-called MUX switch or an add-drop MUX.

Thus, a first table operated device 21 according to the present invention may also send a carrying data stream 1 to a table operated device of a kind different to the aforedescribed second table operated device 22, and a second table operated device 22 according to the present invention can receive a carrying data stream 1 from second table operated devices other than the aforedescribed first table operated device 21.

An arrangement in which a first and a second table operated device shall mutually co-act in accordance with the present invention also includes a control unit 23′ that is adapted to function in accordance with the aforedescribed method.

The first table operated device is adapted to select dynamically a frame structure for the constructed carrying data stream in accordance with current transmission requirements.

An example of one such table operated device is a first table operated device that is related to a number of contact points 21a, 21B, 21c, 21d for incoming streams a, b, c, d.

The first operated device 21 is also related to at least one reception buffer 211a, 21 1b, 211c, 211d in connection with respective contact points 21a, 21b, 21c, 21d, and is adapted to store incoming stream elements, and is also related to a transmission buffer 212 that is adapted to store outgoing stream elements.

A so-called presence vector 213 having a position 213a, 213b, 213c, 213d for each reception buffer 211a, 211b, 211c, 211d is adapted to show in each position 213a, 213b, 213c, 213d whether or not a stream element is stored in an associated reception buffer 211a, 211b, 211c, 211d.

The first table operated device 21 also includes a frame selecting unit 214 that is adapted to translate the presence vector 213 to a table position in the frame descriptive table FDTA belonging to the first table operated device 21, said position indicating a frame structure that corresponds to a transmission requirement in accordance with the presence vector 213.

The first table operated device 21 also includes a frame forming unit 215 which is adapted to construct a frame in accordance with the given frame structure, by storing in the transmission buffer 212 an index that corresponds to the table position in question, and by transferring stream elements from respective reception buffers 211a, 211b, 211c, 211d to the transmission buffer 212 in accordance with the given frame structure. A transmission unit 216 is adapted to send the constructed frame from the transmission buffer 212, either directly or indirectly, to a second table operated device, such as the second table operated device 22, via the carrying data stream 1.

It is possible that stream elements from one and the same incoming stream b are of mutually different types, such as of mutually different sizes.

These stream elements can be handled by allocating different positions in the presence vector 213. The stream elements can also be distinguished from each other, by representing different types of stream elements by different numbers in the same position in the presence vector 213.

According to one preferred embodiment of the present invention, the frame selecting unit 214 includes a number of frame element vectors 2141, 2142, 2143, . . . , 214n, where each position in the frame descriptive table FDTA is represented by a frame element vector.

Respective frame element vectors 2141 include a position 2141a, 2141b, 2141c, 2141d for each position in the presence vector 213, where each position 2141a, 2141b, 2141c, 2141d is adapted to indicate whether or not a stream element stored in a reception buffer 21a, 21b, 21c, 21d, and therewith marked in the presence vector 213, can be transmitted by means of the frame structure represented by the table position that belongs to the frame element vector concerned.

If a part of the index “i” includes a mask, the mask part of the index may be comprised of that part of the presence vector that represents the data streams allocated places in different frame structures by said masking.

This enables the frame selecting unit 214 to find a frame structure that suits the presence vector 213 concerned, by matching between a presence vector 213 and the frame element vectors 2141, 2142, 2143, . . . , 214n.

According to the present invention, the second table operated device 22 is adapted to extract carried data streams from an incoming carrying data stream.

This is possible because the second table operated device is related to an arrival buffer 221 which is adapted to receive frames that belong to the arriving carrying data stream 1, and also related to a number of contact points 22a, 22b, 22c, 22d for outgoing streams a, b, c, d.

The second table operated device 22 is also related to at least one output buffer 222a, 222b, 222c, 222d in connection with respective contact points 22a, 22b, 22c, 22d.

An extraction unit 223 is adapted to extract the stream elements from received frames with a starting point from the index in received frames and the frame descriptive table FDTB for the second table operated device 22, and store respective stream elements in intended output buffers 222a, 222b, 222c, 222d.

According to one preferred embodiment of the present invention, the information present in the frame descriptive table FDTB includes information as to in which output buffer 222a, 222b, 222c, 222d the stream elements concerned shall be stored.

The frame multiplexing principles can be used recursively. In the case of the table operated devices described, this is illustrated by FIGS. 12 and 13 in which a first arrangement 31, 31′ includes a first table operated device 21, 21′ according to the foregoing, and a third table operated device 24, 24′.

A first stream a of the streams incoming to the first table operated device 21 constitutes a carrying stream from the third table operated device 24, said third table operated device 24 being illustrated hereinafter as a table operated device that has the same function as the first table operated device 21. It will be understood, however, that this first table operated device 24 may be any other type of table operated device that transmits a carrying data stream.

In FIGS. 12 and 13, the control stream a′ is comprised of a data stream separate from the carrying stream 1, and the first carried data stream a constitutes the carrying data stream in this case, from the third table operated device.

Thus, the first data stream a incoming to the first table operated device 21 forms a carrying data stream for the data streams e, f and g incoming to the third table operated device 24.

According to this embodiment, the first table operated device 21 is adapted to receive frame structures of different sizes from the third table operated device 24 as though they were different types of stream element.

It is possible in this case for the first table operated device 21 and the third table operated device 24 to form two table operated devices that belong to mutually different units, in accordance with FIG. 12.

The first table operated device 21′ and the third table operated device 24′ may, alternatively, form two table operated devices that belong to a common multiplexing unit, as illustrated in FIG. 13.

FIGS. 11 and 12 also show a second arrangement 32, 32′ that includes a second table operated device 22, 22′ according to the above, and a fourth table operated device 25, 25′ that is adapted to receive a carrying data stream.

When a carrying data stream 1 incoming to a second table operated device 22 includes a first carried data stream a that forms, per se, a carrying data stream formed, e.g., by a first arrangement comprising a first and a third table operated device 21, 24 according to the above, it is proposed in accordance with the invention that the fourth table operated device 25 is adapted to receive the first carried data stream a, by connecting the fourth table operated device 25 to the contact point 22a from which the first data stream a is sent from the second table operated device 22.

The fourth table operated device 25 is illustrated in the following as a table operated device that has the same function as the second table operated device 22. It will be understood, however, that the fourth table operated device 25 may be any other type of table operated device that receives a carrying stream.

The second table operated device 22 and the fourth table operated device 25 may form two table operated devices that belong to a multiplexing unit as illustrated in FIG. 12.

Alternatively, the second table operated device 22′ and the fourth table operated device 25′ may form two table operated devices that belong to mutually different units, in accordance with FIG. 13.

The present invention also relates to a third arrangement 33, 33′ that includes the earlier described first and second arrangements 31, 32, 31′, 32′. In the case of this third arrangement, the first and the second table operated devices 21, 22 can co-act by means of a first table represented locally by the two tables FDTA and FDTB, and the third and fourth table operated devices 24, 25 can co-act by means of a second table represented locally by the two tables FDTC and TDTD.

The first FDTA/FDTB and the second FDTC/TDTD frame descriptive table can be handled either by a common control unit 23′, as shown in FIG. 12, or by two mutually separate control units 23″, 23+″, such as the first frame descriptive table FDTA′/FDTB′ can be handled by a first control unit 23″, and the second frame descriptive table FDTC′/FDTD′ can be handled by a second control unit 23′″ in accordance with FIG. 13.

In the foregoing, recursion is shown in one stage and via a carried data stream which, per se, constitutes a carrying data stream. It will be understood by the person skilled in this art that some or even all streams incoming to a table operated device that creates a carrying data stream may be carrying data streams per se.

It will also be understood that the illustrated table operated devices that co-act within a common unit, such as the first table operated device 21′ and the third table operated device 24′ in FIG. 13, or the second table operated device 22 and the fourth table operated device 25 in FIG. 12, may, in a practical application, be comprised of a physical table operated device that is able to dismantle or create carrying data streams that contain, per se, carrying data streams of different recursion depths. Such a physical table operated device, however, can be seen as two or more logically separated table operated devices each acting in accordance with a frame descriptive table and dismantling or creating a recursion depth. This can be implement, for instance, by a recursively operated algorithm.

It will be understood that the invention is not restricted to the aforedescribed and illustrated exemplifying embodiments thereof and that modifications can be made within the scope of the inventive concept as illustrated in the accompanying Claims.

1. A method of transferring a number of carried data streams from a first table operated device to a second table operated device via a common carrying data stream, wherein a so-called carried data stream is a sequence of mutually related stream elements, wherein said carrying data stream is organised into frames, and wherein each frame includes stream elements that belong to one or more different carried data streams, characterised in that frame multiplexing is used to combine stream elements belonging to one or more different data streams into a common frame; in that used frame structures include a frame descriptive index; in that said index includes a reference to a position in a frame descriptive table stored locally in both said first table operated device and said second table operated device; in that a so-called control stream is setup between a so-called control unit and said first and said second table operated devices; and in that control information required to establish a new frame structure, to change an existing frame structure, or to remove a present frame structure, is transferred between said controlled unit and said first and said second table operated devices via said control stream.

2. A method according to claim 1, characterised in that said index is divided into two parts; in that a first part includes a reference or pointer to a position in said frame descriptive table; and in that a second part includes a mask which enables a number of data streams to be defined, such as transferred with the frame structure concerned.

3. A method according to claim 1 or 2, characterised in that said control information includes information required to unambiguously determine the size and position of respective stream elements included in a changed frame structure; and in that an effected change includes guaranteed consistency between said control unit and said first and second table operated devices respectively with regard to the frame descriptive tables used.

4. A method according to claim 3, characterised in that said control stream is transferred between said first and said second table operated devices separately from said carrying data stream.

5. A method according to claim 3, characterised in that said control stream is comprised of a stream carried by said carrying stream, either completely or partially.

6. A method according to claim 4 or 5, characterised in that said control information includes a type-determination of the control information; and in that said type-determination indicates the type of change to which the stream control information relates and in which phase of the change said stream control information shall be used.

7. A method according to claim 6, characterised in that when including a new data stream in the creation of a new frame structure, said control unit functions to create a new frame structure that includes a new stream element belonging to said new data stream.

8. A method according to claim 7, characterised in that said control unit sends control information to said first and said second table operated devices via said control stream, wherein said control information includes a type-determination of said message, a disclosure of a new frame descriptive index, a disclosure of the identity of a new data stream, a disclosure of a start address for the new stream element within the new frame structure, and a disclosure of the length of said new stream element; and in that said first and said second table operated devices return the control information to said control unit via said control stream, wherein said control information includes a type-determination of said message, an identification of said new frame descriptive index, and a terminating address for said new stream element within said new frame structure.

9. A method according to claim 6, characterised in that with the insertion of a new data stream into an existing frame structure, the control unit functions to create a new frame structure where a new stream element belonging to said new data stream is added after the last stream element belonging to a frame according to the old frame structure.

10. A method according to claim 9, characterised in that said control unit sends control information to said first and said second table operated devices via said control stream, wherein said control information includes a message type-determination, an identification of the old frame descriptive index, a disclosure of the new data stream identity, a disclosure of the start address for a new stream element within the new frame structure, and a disclosure of the length of said new stream elements; and in that said first and said second table operated devices returns the control information to said control unit via said control stream, wherein said control information includes a message type-determination, an identification of said new frame descriptive index, and a terminating address for said new stream element within said new frame structure.

11. A method according to claim 6, characterised in that in removing an existing data stream in an existing frame structure, said control unit functions to create a new frame structure from which the stream elements concerned are excluded.

12. A method according to claim 11, characterised in that said control unit sends control information to said first and said second table operated devices via said control stream, wherein said control information includes a message type-determination, identification of the old frame descriptive index, a disclosure of a new frame descriptive index, and a disclosure of the identity of removed data stream; and in that said first and said second table operated devices return the control information to said control unit via said control stream, wherein said control information includes a message type-determination, identification of said new frame descriptive index, and a new frame structure terminating address.

13. A method according to claim 6, characterised in that in changing available space for an existing stream element in an existing frame structure, said control unit functions to create a new frame structure which excludes the stream elements concerned, wherein any subsequent stream elements accompany any preceding stream elements, and wherein a new stream element with the new space is added to the end of the frame structure concerned.

14. A method according to claim 13, characterised in that said control unit sends control information to said first and said second table operated devices via said control stream, wherein said control information includes a message type-determination, identification of the old frame descriptive index, a disclosure of a new frame descriptive index, a disclosure of the identity of the data stream concerned, a disclosure of the start address of a new stream element within the new frame structure, and a disclosure of the length of said new stream element; and in that said first and said second table operated devices return control information to said control unit via said control stream, wherein said control information includes a message type-determination, an identification of said new frame descriptive index, and a terminating address for said new stream elements within said new frame structure.

15. A method according to claim 8, 10, 12 or 14, characterised in that the frame descriptive table concerned is updated in accordance with given instructions at said first and said second table operated devices; and in that a respective change to a frame structure is terminated with an acknowledgement message from said control unit to said first and said second table operated devices and from said first and said second table operated devices to said control unit via said control stream, wherein the control information includes a message type-determination and an identification of said new frame descriptive index, whereafter said new frame structure can be used.

16. A method according to claim 3, characterised in that in the removal of an existing frame structure said control unit functions to remove a corresponding position in the frame descriptive table of said first and said second table operated devices.

17. A method according to claim 16, characterised in that said control unit sends control information to said first and said second table operated devices via said control stream, wherein said control information includes a message type-determination and a disclosure of the frame descriptive index of the removed frame structure; and in that said first and said second table operated devices return control information to said control unit via said control stream, wherein said control information includes a message type determination and a disclosure of the frame descriptive index of the removed frame structure.

18. A method according to any one of claims 5 to 17, characterised in that control information belonging to two or more changes that concern the same or different frame structures is transferred in a common stream element belonging to said control stream.

19. A method according to any one of claims 5 to 18, characterised in that a plurality of different frame structures include a stream element belonging to said control stream.

20. A method according to any one of claims 5 to 18, characterised in that all available frame structures include a stream element belonging to said control stream.

21. A method according to claim 4 or 5, characterised in that said control unit is adapted to form internally said frame descriptive table in accordance with requisite changes; and in that said control information includes a thus formed table.

22. A method according to claim 21, characterised in that said frame descriptive table is sent to said first and said second table operated devices; and in that the consistency between said control unit and said first and second table operated devices is guaranteed with respect to the frame descriptive table used.

23. A method according to any one of the preceding claims, characterised in that said first table operated device is adapted to multiplex incoming data streams to a common carrying data stream; and in that said first table operated device is adapted to select dynamically a frame structure in accordance with the current transmission requirement in forming said carrying data stream.

24. A method according to claim 23, characterised in that said first table operating device includes a so-called presence vector; in that said presence vector represents the current requirement for said first table operated device; in that a frame selecting unit includes a number of frame element vectors; in that each position in said frame descriptive table is represented by a frame element vector; in that respective frame element vectors include a position for each position in said presence vector; in that each position indicates whether or not a stream element marked in said presence vector can be transmitted by means of the frame structure that is represented by the table position that belongs to the frame element vector concerned; and in that said frame selecting unit can find a frame structure that suits the current transmission requirement by matching between a presence vector and said frame element vectors.

25. A method according to claim 24, characterised in that said frame element vectors are updated in conjunction with updating said frame descriptive table.

26. A method according to claim 23, 24 or 25, characterised in that said first table operated devices form a recursively constructed carrying data stream from said incoming data streams.

27. A method according to any one of claims 1 to 22, characterised in that said second table operated devices are adapted to demultiplex an incoming carrier data stream by causing said second table operated devices to extract carried data streams from said incoming carrying data stream.

28. A method according to claim 27, characterised in that said second table operated devices are caused to extract said carried data streams from a recursively constructed carrying data stream.

29. A table operated device, characterised in that said device includes a frame descriptive table that discloses how different frame structures are constructed and whereby a transformation between carried data streams and a carrying data stream is possible; in that said table can be changed or updated in accordance with instructions from a control device; and in that said table operated device is adapted to function in a group of two or more table operated devices where a common table is used within said group to enable a common definition of frame structures employed in the group to be used.

30. A first table operated device according to claim 29, characterised in that said first table operated device is adapted to multiplex incoming data streams; and in that said first table operated device is adapted to select dynamically a frame structure in accordance with the current transmission requirement in creating a carrying data stream.

31. A first table operated device in accordance with claim 29, characterised in that said first table operated device is related to a number of contact points for incoming streams, to at least one reception buffer in connection with respective contact points adapted to store incoming stream elements, and to a transmission buffer adapted to store outgoing stream elements; in that a so-called presence vector having a position for each reception buffer is adapted to indicate in each position whether or not a stream element is stored in a respective reception buffer; in that a frame selecting unit is adapted to translate said presence vector to a table position in said frame descriptive table, said position denoting a frame structure that corresponds to a transmission requirement according to said presence vector; in that a frame forming unit is adapted to form a frame according to the given frame structure by storing in said transmission buffer an index that corresponds to said table position, and by transmitting stream elements from respective reception buffers to said transmission buffer in accordance with the given frame structure; and in that a transmission unit is adapted to transmit said formed frame from said transmission buffer as a carrying data stream.

32. A first table operated device according to claim 31, characterised in that stream elements from one and the same incoming stream may be of different types, such as of different sizes; and in that different types of stream elements from the same incoming data stream are allocated different positions in said presence vector.

33. A first table operated device according to claim 31, characterised in that stream elements from one and the same incoming stream may be of different types, such as of different sizes; and in that different types of stream elements from the same incoming data stream are represented by different numbers in the same positions within said presence vector.

34. A first table operated device according to claim 31, 32 or 33, characterised in that said frame selecting unit includes a number of frame elements vectors; in that each position in said frame descriptive table is represented by a frame element vector; in that respective frame element vectors include a position for each position in said presence vector; in that each position is adapted to show whether or not a stream element stored in a reception buffer, and therewith marked in said presence vector, can be transmitted by means of the frame structure represented by the table position that belongs to the frame element vector concerned; and in that said frame selecting unit is able to find a frame structure that suits said presence vector by matching between a presence vector and said frame element vectors.

35. A second table operated device according to claim 29, characterised in that said second table operated device is adapted to demultiplex an incoming carrying data stream; and in that said second table operated device is adapted to extract carried data streams from an incoming carrying data stream.

36. A second table operated device according to claim 35, characterised in that said second table operated device is related to an input buffer adapted to receive frames belonging to an incoming carrying data stream, and to a number of contact points for outgoing streams, and also to an output buffer in connection with respective contact points; in that an extraction unit is adapted to extract stream elements from received frames with a starting point from index and said frame descriptive table, and store respective stream elements in intended output buffers.

37. A second table operated device according to claim 36, characterised in that the frame descriptive table contains information as to whether respective stream elements include information as to which output buffer the stream element concerned shall be stored.

38. A first arrangement comprising a first table operated device according to any one of claims 30 to 34, characterised in that a first stream of said incoming streams constitutes a carrying stream from a third table operated device; and in that said third table operated device is adapted to transmit a carrying data stream.

39. A first arrangement according to claim 38, characterised in that said first table operated device is adapted to receive frame structures of different sizes from said third table operated device, such as different types of stream elements.

40. A first arrangement according to claim 38 or 39, characterised in that said first table operated device and said third table operated device form two table operated devices belonging to a common multiplexing unit.

41. A first arrangement according to claim 38 or 39, characterised in that said first table operated device and said third table operated device form two table operated devices that belong to mutually different units.

42. A second arrangement comprising a second table operated device according to claim 35, 36 or 37, wherein said incoming carrying data stream includes a first carried data stream, and wherein said first carried data stream constitutes a carrying data stream per se, characterised in that the arrangement includes a fourth table operated device which is adapted to receive said first carried data stream from said second table operated device; and in that said fourth table operated device is adapted to receive a carrying data stream.

43. A second arrangement according to claim 42, characterised in that said second table operated device and said fourth table operated device form two table operated devices that belong to a common demultiplexing unit.

44. A second arrangement according to claim 42, characterised in that said second table operated device and said fourth table operated device form two table operated devices that belong to mutually different units.

45. A third arrangement comprising a first arrangement according to claims 38 to 41, and a second arrangement according to claims 42 to 44, characterised in that said first and said second table operated devices co-act by means of a first table; and in that said third and said fourth table operated devices co-act by means of a second table.

46. A third arrangement according to claim 45, characterised in that said first table and said second table are handled by a common control unit.

47. A third arrangement according to claim 45, characterised in that said first table is handled by a first control unit; and in that said second table is handled by a second control unit.
